(19) United States
(12) Patent Application Publication
(10) Pub. No.: US 2004/0090218 A1
(43) Pub. Date: May 13, 2004

(54) Self-powered over-voltage protection circuit

(75) Inventor: Robert Haynes Isham, Flemington, NJ (US)

Correspondence Address: CHARLES E. WANDS, ESQ., ALLEN, DYER, DOPPELT, MILBRATH & GILCHRIST, P.A., 255 SOUTH ORANGE AVENUE, SUITE 1401, P.O. BOX 3791, ORLANDO, FL, 32802-3791, US

(73) Assignee: Intersil Americas Inc., Milpitas, CA

(21) Appl. No.: 10/691,251

(22) Filed: Oct. 22, 2003

Related U.S. Application Data
(60) Provisional application No. 60/425,485, filed on Nov. 12, 2002.

(51) Int. Cl. G05F 1/40

(52) U.S. Cl. 323/282

(57) ABSTRACT

A self-powered overvoltage protection circuit for a regulated DC-DC converter looks for the onset of a very large input voltage prior to regulation. In response to such a voltage during this interval, it turns on a low side electronic power switching device, in accordance with the voltage at one of the phase node and the regulated voltage output terminal from which the protection circuit derives its power. This provides a bypass path for an overvoltage that would otherwise be coupled from the regulated voltage output terminal to one or more load devices.

### CROSS-REFERENCE TO RELATED APPLICATION

The present application claims the benefit of copending U.S. application Ser. No. 60/425,485, filed Nov. 12, 2002, entitled: “Self-Powered Over-Voltage Detection Circuit,” assigned to the assignee of the present application and the disclosure of which is incorporated herein.

### FIELD OF THE INVENTION

The present invention relates, in general, to power supply systems and subsystems thereof, and is particularly directed to a new and improved self-powered overvoltage protection circuit for a regulated DC-DC converter. As will be described the over voltage protection circuit of the invention is powered off the load. It is operative, in response to the converter's output voltage exceeding a prescribed threshold (such as may be associated with the onset of a very large input voltage prior to regulation), to turn on a low side electronic power switching device in accordance with the voltage at one of the phase node and the regulated voltage output terminal, to thereby provide a bypass path for an overvoltage that would otherwise be coupled from the regulated voltage output terminal to one or more load devices.

### BACKGROUND OF THE INVENTION

A reduced complexity diagram of a buck topology-based DC-DC converter is shown in FIG. 1 as comprising a pulse width modulation (PWM) controller 10, which is powered by a bias supply Vbias, and contains an output driver stage 12 coupled to the gate inputs of an upper or high side electronic switching device (shown as a MOSFET or UFET 20), and a lower or low side electronic switching device (shown as a MOSFET or LFET 30), which are alternately turned on and off by the PWM controller in a prescribed manner, to provide a regulated DC ripple voltage at an output node Vout.

The UFET 20 and the LFET 30 have their source-drain paths coupled between an input voltage terminal Vin and a reference voltage terminal shown as ground. The common connection or phase node 25 between the UFET 20 and LFET 30 is coupled through an inductor 40 to the output node Vout, to which a load is coupled. An output capacitor 45 referenced to ground is also coupled to the output node. The voltage at the output node Vout is fed back to an error amplifier within the PWM controller for adjusting the controller's parameters, so as to maintain the output voltage within a prescribed regulation specification.

When the regulated DC converter is operating properly, no power is allowed to be coupled from the input to the output until the controller has been properly biased and is ready to regulate. During this ‘precursor to regulated power’ conversion period, both the UFET 20 and the LFET 30 are held in their off states, so as to prevent the voltage at terminal Vin from being applied to the output. However, under one or more fault conditions, such as a short across the UFET 20 (for example, due to a solder whisker), a 12 volt supply voltage at the voltage input terminal Vin coupled to the terminal Vin may be directly coupled through the shorted UFET 20 and inductor 40 to the output terminal Vout. Such a large voltage may cause damage to one or more load devices, such as a microprocessor, that is to be powered by the DC voltage regulator.

### SUMMARY OF THE INVENTION

In accordance with the present invention, this problem is effectively obviated by a self-powered overvoltage protection circuit that is powered by and monitors the output terminal Vout for the onset of an unacceptably high voltage. In response to the output voltage reaching a prescribed threshold voltage, the protection circuit is operative to turn on the LFET, so as to provide a by-pass path for the high voltage through the source-drain path of the LFET, thereby preventing the overvoltage condition from causing damage to one or load devices that are coupled to the output terminal.

For this purpose, the DC converter's PWM controller is modified to incorporate a self-powered overvoltage protection circuit which is coupled to monitor the voltage at the converter's output terminal Vout. The overvoltage protection circuit employs a comparator that is coupled to receive a pair of threshold voltage references, such as an upper voltage threshold on the order of 1.8 VDC, and a lower threshold voltage on the order of 1.5 VDC, for example. If the monitored voltage exceeds the upper voltage threshold, the comparator is tripped, and applies a turn-on voltage to the control input of a switch coupled in series with the LFET drive path of a driver stage, and either the phase node or the output voltage terminal Vout.

As a result, the substantial voltage applied to either the phase node or the output terminal Vout is coupled instead through the driver stage to the gate of the LFET, so that the LFET turns on hard. Turning on the LFET in this manner provides a bypass path for the voltage Vin, so that, rather than being applied to the output terminal Vout, the excessive voltage is instead coupled through the source-drain path of the LFET to ground. The comparator remains tripped until the monitored voltage drops below the second reference voltage. This should happen as the PWM controller becomes active. Once the PWM controller becomes active it disables the operation of the overvoltage protection circuit, so that the UFET and the LFET may be controlled in their normal manner by the PWM controller.

### BRIEF DESCRIPTION OF THE DRAWINGS

FIG. 1 is a reduced complexity diagram of a buck topology-based DC-DC converter; and

FIG. 2 shows an augmentation of the buck topology-based DC-DC converter of FIG. 1 to incorporate the overvoltage protection circuit of the present invention.

### DETAILED DESCRIPTION

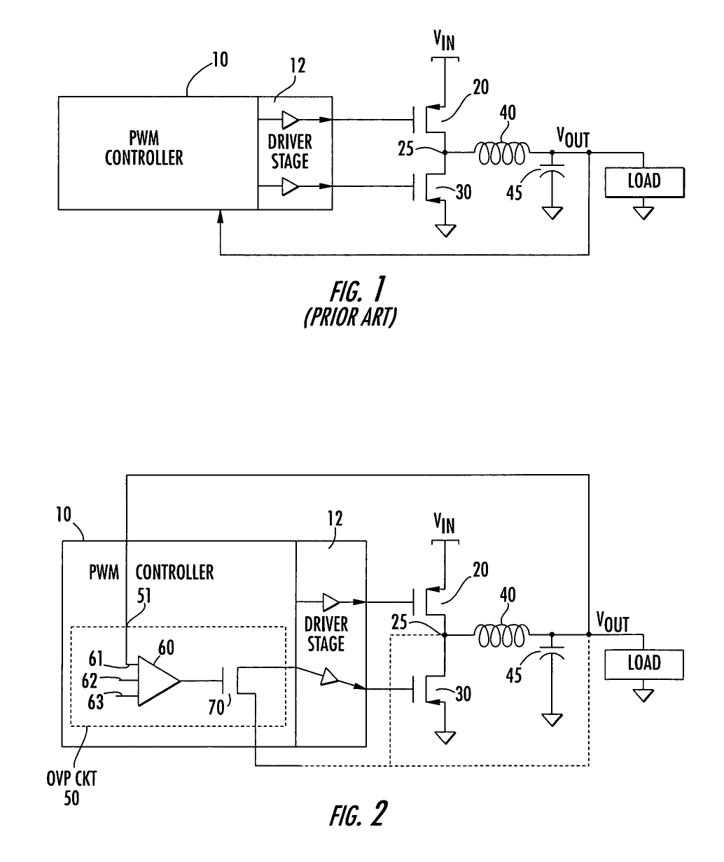

Attention is now directed to FIG. 2, which shows the manner in which the buck topology-based DC-DC converter of FIG. 1 may be augmented to incorporate the overvoltage protection circuit of the present invention. In particular, the PWM controller 10 is modified to incorporate a self-powered overvoltage protection circuit 50 which is powered by and has a first input 51 coupled to monitor the voltage at the output terminal Vout. Within the overvoltage protection circuit 50, input 51 is coupled to a first input 61 of a comparator 60, a second input 62 of which is coupled to receive a first reference voltage, such as a voltage on the order of 1.8 VDC, for example, and a third input 63 of which is coupled to receive a second reference voltage, such as a voltage on the order of 1.5 VDC, for example.

If the voltage supplied to the first input 61 of comparator 60 exceeds the first reference voltage (e.g., 1.8 VDC in the present example), the comparator is tripped, so that it applies a turn-on voltage to the control input of a switch (shown as an FET) 70, which has its source-drain path coupled in series with the LFET drive path of driver stage 12 and either the phase node 25 or the output voltage terminal Vout. The comparator remains tripped until the voltage applied to input 61 drops below the second reference voltage (1.5 VDC in the present example).

In operation, as pointed out above, during a precursor to regulated power conversion period, if the converter is operating properly, no power can be coupled from the input to the output until the controller 10 has been properly biased and is ready to regulate. During this time both the UFET 20 and the LFET 30 are held in their off state by the PWM controller, so as to prevent the voltage at terminal Vin from being applied to the output, so that the output remains low.

Let it be assumed, however, that a fault condition exists, such as a short across the UFET 20 due to a whisker of solder bridging the source-drain path of the UFET. With a 12 volt supply voltage coupled to the terminal Vin this voltage can now be directly coupled through the shorted UFET 20 and inductor 40 to the output terminal Vout. As the voltage at the output terminal Vout begins to ramp up towards this large voltage rail, it eventually reaches the trip voltage (e.g., 1.8 VDC) of the comparator 60 of the overvoltage protection circuit.

In response this trip event, comparator asserts a gate turn on voltage at its output 63 to the gate of FET 70. Since the source-drain path of FET 70 is coupled in series with one of the phase node 25 and the output terminal Vout, the substantial voltage applied to the phase node 25 and inductor 50 to the output terminal Vout, as a result of the short across the UFET 20, is now coupled instead through the driver stage 12 to the gate of LFET 30, so that LFET 30 is turned on.

Turning on LFET 30 in this manner provides a bypass path for the voltage Vin, so that, rather than being applied through the inductor 40 to the output terminal Vout, the excessive voltage is instead coupled through the source-drain path of LFET 30 to ground. With this action, the voltage at the output terminal will begin to drop. Once it drops below the second reference voltage (e.g., 1.5 VDC), the comparator 60 will be tripped to remove its gating input to FET 70. This should happen as the PWM controller becomes active. Once the PWM controller becomes active it disables the operation of the overvoltage protection circuit, so that UFET 20 and LFET 30 are controlled in their normal manner by the PWM controller.

While I have shown and described an embodiment in accordance with the present invention, it is to be understood that the same is not limited thereto but is susceptible to numerous changes and modifications as known to a person skilled in the art, and I therefore do not wish to be limited to the details shown and described herein, but intend to cover all such changes and modifications as are obvious to one of ordinary skill in the art.

What is claimed:

1. For use with a DC-DC voltage converter having a controller which switchably controls operation of first and second electronic power switching devices coupled between respective power supply terminals, and having a phase node thereof coupled through an inductor to a regulated voltage output terminal, a method of protecting one or more load devices that may be coupled to said regulated voltage output terminal, comprising the steps of:
(a) deriving power from and monitoring the voltage at said regulated voltage output terminal;
(b) in response to the voltage monitored in step (a) exceeding a prescribed threshold, turning on said second electronic power switching device in accordance with the voltage at one of said phase node and said regulated voltage output terminal, to thereby provide through said second electronic power switching device a bypass path for an overvoltage that would otherwise be coupled from said regulated voltage output terminal to said one or more load devices.

2. The method according to claim 1, wherein step (b) comprises, in response to the voltage monitored in step (a) exceeding said prescribed threshold, turning on said second electronic power switching device in accordance with the voltage at said phase node, to thereby provide said bypass path for an overvoltage that would otherwise be coupled from said regulated voltage output terminal so said one or more load devices.

3. The method according to claim 1, wherein step (b) comprises, in response to the voltage monitored in step (a) exceeding said prescribed threshold, turning on said second electronic power switching device in accordance with the voltage at said voltage output terminal, to thereby provide said bypass path for an overvoltage that would otherwise be coupled from said regulated voltage output terminal so said one or more load devices.

4. The method according to claim 1, further including step (c) of, in response to the voltage monitored in step (a) dropping below predetermine value, turning off said second electronic power switching device.

5. For use with a DC-DC voltage converter having a controller which switchably controls operation of first and second electronic power switching devices coupled between respective power supply terminals, and having a phase node thereof coupled through an inductor to a regulated voltage output terminal, an arrangement for protecting one or more load devices that may be coupled to said regulated voltage output terminal, comprising:
an overvoltage detection circuit that derives its power from and is operative to monitor the voltage at said regulated voltage output terminal;
a switching circuit that is operative, in response to the voltage monitored by said overvoltage detection circuit exceeding a prescribed threshold, to turn on said second electronic power switching device in accordance with the voltage at one of said phase node and said regulated voltage output terminal, to thereby provide a bypass path for an overvoltage that would otherwise be coupled from said regulated voltage output terminal to said one or more load devices.

6. The arrangement according to claim 5, wherein said switching circuit is operative, in response to the voltage monitored by said overvoltage detection circuit exceeding said prescribed threshold, to turn on said second electronic power switching device, in accordance with the voltage at said phase node to thereby provide said bypass path for an overvoltage that would otherwise be coupled from said regulated voltage output terminal so said one or more load devices.

7. The arrangement according to claim 5, wherein said switching circuit is operative, in response to the voltage monitored by said overvoltage detection circuit exceeding said prescribed threshold, to turn on said second electronic power switching device, in accordance with the voltage at said output terminal to thereby provide said bypass path for an overvoltage that would otherwise be coupled from said regulated voltage output terminal so said one or more load devices.

8. The arrangement according to claim 5, wherein said overvoltage detection circuit is operative, in response to the voltage monitored thereby dropping below predetermine value, to cause said switching circuit to turn off said second electronic power switching device.

9. In a DC-DC voltage converter having a controller which generates pulse width modulation (PWM) switching signals that switchably control operation of first and second electronic power switching devices coupled between respective power supply terminals, and having a phase node thereof coupled through an inductor to a regulated voltage output terminal, the improvement comprising:
an overvoltage detector that derives its power from and is operative to monitor the voltage at said regulated voltage output terminal; and
a switch that is operative, in response to the voltage monitored by said overvoltage detector exceeding a prescribed threshold, to turn on said second electronic power switching device in accordance with the voltage at one of said phase node and said regulated voltage output terminal, and thereby provide a bypass path for an overvoltage that would otherwise be coupled from said regulated voltage output terminal to one or more load devices.

10. The improvement according to claim 9, wherein said switch is operative, in response to the voltage monitored by said overvoltage detector exceeding said prescribed threshold, to turn on said second electronic power switching device, in accordance with the voltage at said phase node to thereby provide said bypass path for an overvoltage that would otherwise be coupled from said regulated voltage output terminal so said one or more load devices.

11. The improvement according to claim 9, wherein said switch is operative, in response to the voltage monitored by said overvoltage detector exceeding said prescribed threshold, to turn on said second electronic power switching device, in accordance with the voltage at said output terminal to thereby provide said bypass path for an overvoltage that would otherwise be coupled from said regulated voltage output terminal so said one or more load devices.

12. The improvement according to claim 9, wherein said overvoltage detector is operative, in response to the voltage monitored thereby dropping below predetermine value, to cause said switch to turn off said second electronic power switching device.
